(19) United States
(12) Patent Application Publication
(10) Pub. No.: US 2019/0071126 A1
(43) Pub. Date: Mar. 7, 2019

(54) DRIVER ASSISTANCE SYSTEM

(71) Applicant: FORD GLOBAL TECHNOLOGIES, LLC, Dearborn, MI (US)

(72) Inventors: Andreas GIERSIEFER, Leverkusen (DE); Jens DORNHEGE, Pulheim (DE); Patrick GLET, Cologne (DE); Christoph KLEIN, Cologne (DE)

(73) Assignee: FORD GLOBAL TECHNOLOGIES, LLC, Dearborn, MI (US)

(21) Appl. No.: 16/123,305

(22) Filed: Sep. 6, 2018

(30) Foreign Application Priority Data
Sep. 7, 2017 (DE) 10 2017 215 737.2

(51) Int. Cl. B62D 15/02; G06K 9/00; B60W 30/12

(52) U.S. Cl. CPC B62D 15/025; G06K 9/00798; B60W 2420/42; B60W 2550/146; B60W 30/12

(57) ABSTRACT

The present disclosure relates to a driver assistance system to support or automate the transverse control of a vehicle by applying a steering torque to an electrically assisted steering system. The driver assistance system is configured to determine a target value for a course curvature of a movement path of the vehicle, which the transverse control is based through a calculation of a Bézier curve. The calculation uses images of a traffic lane, recorded via a camera, located in front of the vehicle.

### CROSS-REFERENCE TO RELATED APPLICATIONS

This application claims foreign priority benefits under 35 U.S.C. § 119(a)-(d) to DE Application 10 2017 215 737.2 filed Sep. 7, 2017, which is hereby incorporated by reference in its entirety.

### TECHNICAL FIELD

The present disclosure relates to a driver assistance system. to support or automate transverse control of a vehicle.

### BACKGROUND

To an increasing degree, driver assistance systems are standard equipment of modern vehicles. A development from safety-related warning systems through convenience-related systems is taking place in driver assistance systems for lateral control. This means that the driver assistance systems concerned are not only switched on or activated in the case of danger, but permanently support a driver through implementation of a lateral vehicle control.

In relation to prior art, it is referred, merely by way of example, to US 2017/0083027 A1 and to the publications Ji-wung Choi et al.: “Continuous Curvature Path Generation Based on Bézier Curves for Autonomous Vehicles”, IAENG International Journal of Applied Mathematics, 40:2, 2010 and also to Wei Li: “Human-like Driving for Autonomous Vehicles using Vision-based Road Curvature Modeling”, International Journal of Hybrid Information Technology, Vol. 6, No. 5 (2013), pages 101-116.

### SUMMARY

It is an object of the present disclosure to provide a driver assistance system that permits a smooth, regularly curved guidance of a vehicle along a predetermined traffic lane (e.g. recorded with camera support).

A driver assistance system according to the disclosure to support or automate transverse control of a vehicle by applying a steering torque to a steering system of the vehicle is configured to determine a target value for a course curvature of a movement path of the vehicle on which the transverse control is based, through calculation of a Bézier curve, wherein this calculation takes place on a basis of a camera-supported recording of a traffic lane located in front of the vehicle.

The disclosure is based in particular on a concept of planning a smooth or regularly curved path for guidance of a vehicle along a traffic lane that is recorded with a camera by making use of cubic Bézier curves. The respective Bézier curve here describes a path from a front edge of the vehicle to a point on a virtual path on the traffic lane, which can here in particular be a center between traffic lane markings. The Bézier curve ends tangentially to a virtual path of the traffic lane. An end point here is located at a position in front of the vehicle that depends on a vehicle speed.

The concept according to the disclosure has an advantage that lateral acceleration, jerk and yaw rate of the vehicle can be minimized, whereby a comfortable driving behavior is achieved. The concept according to the disclosure furthermore permits a minimization of steering wheel movement and acceleration, whereby an optimum steering sensation can be achieved.

According to one form of embodiment, a camera-supported recording of a traffic lane located in front of the vehicle comprises a determination of at least one, in particular all, of the following parameters: current course curvature of a roadway, distance between a center line of the roadway and a center of gravity of the vehicle, and an angle between the center line of the roadway and a center line of the vehicle.

According to one form of embodiment, a determination of a target value (or planning of a future movement path) takes place while taking current vehicle movement into account.

According to one form of embodiment, delays in processing of camera images and/or in a CAN interface are taken into account.

According to one form of embodiment, furthermore, different task times of traffic lane recognition (i.e. of a camera system) on the one hand and of lane tracking (i.e. of a steering system) on the other hand are taken into account.

A calculation of a yaw rate of the vehicle can be performed with reference to a Bézier curve in forms of embodiment of the disclosure.

According to one form of embodiment, a driver assistance system comprises an outer control loop and an inner control loop, wherein the outer control loop provides a target value for a course curvature of a movement path of the vehicle as an input parameter for the inner control loop, and wherein the inner control loop provides a steering torque as an output signal.

According to one form of embodiment, the inner control loop comprises a PID controller.

The disclosure is next explained in more detail with reference to an exemplary embodiment with reference to the appended drawings.

### BRIEF DESCRIPTION OF THE DRAWINGS

FIG. 1 shows a diagram for the explanation of parameters relevant to a movement path planning according to the disclosure; and

FIG. 2 shows a schematic illustration for explanation of a control concept realized in the context of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

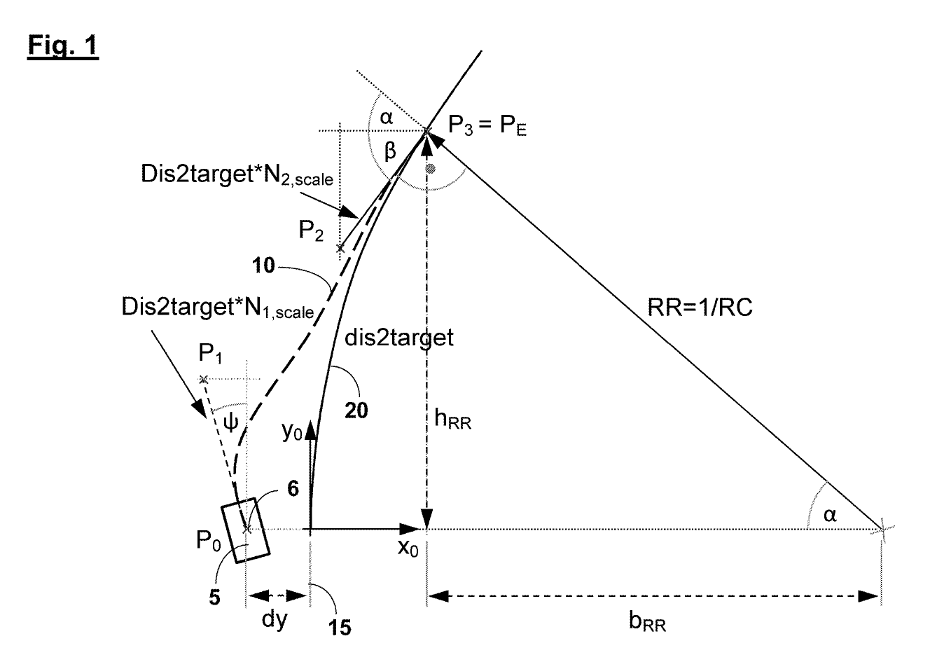

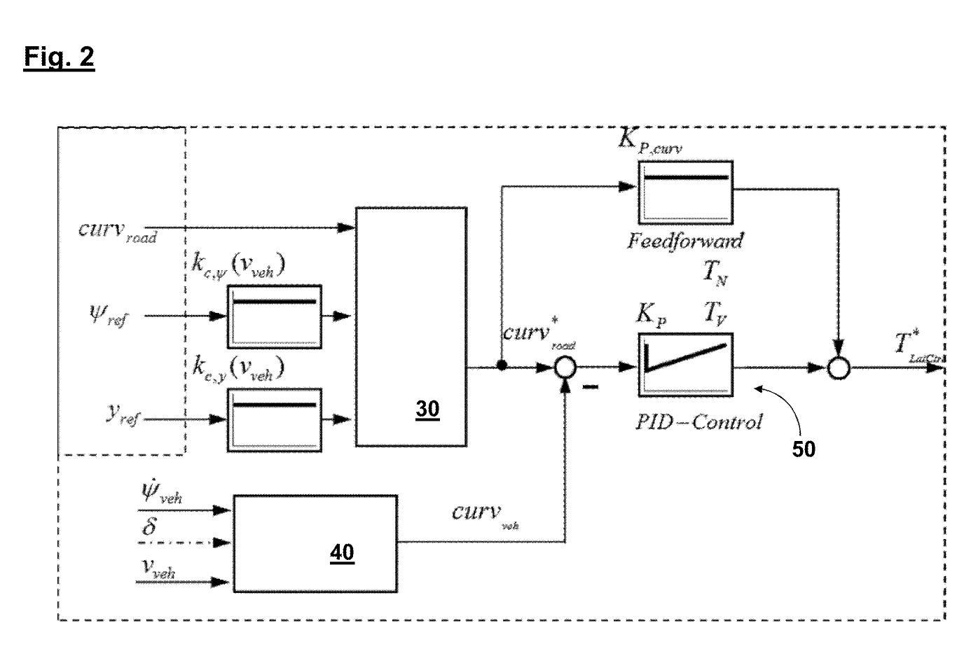

A calculation of a Bézier curve and its application to the transverse control of a vehicle with reference to FIG. 1 and FIG. 2 are explained subsequently. In general, an n-th degree Bézier curve can be represented as

$$\begin{matrix}\underline{P} ( t ) = [ \begin{matrix}{P}_{x} \\ {P}_{y}\end{matrix} ] = {\sum }_{i = 0}^{n} {B}_{i}^{n} ( t ) \cdot {\underline{P}}_{i} t ∈ [ 0 , 1 ] \\ wherein & ( 1 ) \\ {B}_{i}^{n} ( t ) = ( \begin{matrix}n \\ i\end{matrix} ) \cdot {( 1 - t )}^{n - i} \cdot {t}^{i} = \frac{n !}{i ! \cdot ( n - i ) !} \cdot {( 1 - t )}^{n - i} \cdot {t}^{i} & ( 2 )\end{matrix}$$

is the Bernstein polynomial for i=1 . . . n. In forms of embodiment of the disclosure, a cubic Bézier curve (with n=3) is in particular used for (micro-)path planning, according to

$$\underline{P} ( t ) = [ \begin{matrix}{P}_{x} ( t ) \\ {P}_{y} ( t )\end{matrix} ] = {( 1 - t )}^{3} \cdot {\underline{P}}_{0} + 3 \cdot {( 1 - t )}^{2} \cdot t \cdot {\underline{P}}_{1} + 3 ( 1 - t ) \cdot {t}^{2} \cdot {\underline{P}}_{2} + {t}^{3} \cdot {\underline{P}}_{3} \qquad ( 3 )$$

In FIG. 1, a vehicle fitted with a driver assistance system according to the disclosure is identified with “Ψ”. An angle between a center line 15 of a roadway and a center line of the vehicle 5 is identified with “P” (wherein, by definition, a positive angle corresponds to an alignment of the vehicle 5 towards the left). A distance between the center line 15 of the roadway and a center of gravity 6 of the vehicle 5 is identified with “dy” (wherein, by definition, a distance is positive if the vehicle 5 is located to a right of the center line 15). A current course curvature of the roadway is identified with “RC” (wherein, by definition, this course curvature is positive if the roadway turns to a left).

A distance of a reference coordinate system (x₀, y₀) drawn in FIG. 1 to a path endpoint on the center 15 of the roadway (corresponding, in the Bézier approach, to a Bézier path, drawn in FIG. 1 as a dotted line and identified with “10”) is identified with “Dis2target”, while N₁, N₂ are scaling values for lengths of tangents at a beginning and end of the Bézier path 10.

On the basis of camera-based measurement of parameters Ψ and dy, and freely selectable values Dis2target, N₁ and N₂, Bézier points are specified as follows:

$$\begin{matrix}{\underline{P}}_{0} = [ \begin{matrix}dy \\ 0\end{matrix} ] \\ {\underline{P}}_{1} = [ \begin{matrix}dy - sin ( ψ ) \cdot dis 2 target \cdot {N}_{1 , scale} \\ cos ( ψ ) \cdot dis 2 target \cdot {N}_{1 , scale}\end{matrix} ] \\ {\underline{P}}_{2} = {\underline{P}}_{3} - [ \begin{matrix}cos ( \frac{π}{2} - α ) \cdot dis 2 target \cdot {N}_{2 , scale} \\ sin ( \frac{π}{2} - α ) \cdot dis 2 target \cdot {N}_{2 , scale}\end{matrix} ] \\ {\underline{P}}_{3} = {\underline{P}}_{E} = [ \begin{matrix}- RR + {b}_{RR} \\ {h}_{RR}\end{matrix} ] = [ \begin{matrix}- \frac{1}{RC} + \frac{1}{RC} \cdot cos ( α ) \\ \frac{1}{RC} \cdot sin ( α )\end{matrix} ] \\ with & ( 4 ) \\ α = dis 2 target \cdot RC \\ and & ( 5 ) \\ {N}_{1 , scale} = {N}_{1} + {\vert α \vert}^{2} \cdot {N}_{factor} \\ {N}_{2 , scale} = {N}_{2} + {\vert α \vert}^{2} \cdot {N}_{factor} & ( 6 )\end{matrix}$$

for curvature calculation. The following auxiliary parameters are used for the sake of greater clarity:

$${b}_{RR} = \frac{1}{RC} \cdot cos ( α ) \\ {h}_{RR} = \frac{1}{RC} \cdot sin ( α ) \qquad ( 7 )$$

An arithmetic signs of measured values are to be taken into account for the Bézier point calculation. The Bézier path 10 can now be calculated according to equation (3). An exact Bézier path is of less significance for the lateral control than the course curvature at a beginning of the Bézier path. By differentiating equation (3) according to

$$\begin{matrix}\underline{\dot{P}} ( t ) = [ \begin{matrix}{\dot{P}}_{x} ( t ) \\ {\dot{P}}_{y} ( t )\end{matrix} ] = 3 \cdot {( 1 - t )}^{2} \cdot ( {\underline{P}}_{1} - {\underline{P}}_{0} ) + 6 \cdot ( 1 - t ) \cdot t \cdot ( {\underline{P}}_{2} - {\underline{P}}_{1} ) + 3 \cdot {t}^{2} ( {\underline{P}}_{3} - {\underline{P}}_{2} ) \\ and & ( 8 ) \\ \underline{\ddot{P}} ( t ) = [ \begin{matrix}{\ddot{P}}_{x} ( t ) \\ {\ddot{P}}_{y} ( t )\end{matrix} ] = 6 \cdot ( 1 - t ) \cdot ( {\underline{P}}_{2} - 2 \cdot {\underline{P}}_{1} + {\underline{P}}_{0} ) + 6 \cdot t \cdot ( {\underline{P}}_{3} - 2 \cdot {\underline{P}}_{2} + {\underline{P}}_{1} ) & ( 9 )\end{matrix}$$

the course curvature of the Bézier path 10 can be calculated according to

$${RC}_{Bezier} ( t ) = \frac{1}{{RR}_{Bezier}} = \frac{{\dot{P}}_{x} ( t ) \cdot {\ddot{P}}_{y} ( t ) - {\dot{P}}_{y} ( t ) \cdot {\ddot{P}}_{x} ( t )}{{( {\dot{P}}_{x}^{2} ( t ) - {\dot{P}}_{y}^{2} ( t ) )}^{\frac{3}{2}}} \qquad ( 10 )$$

In the general concept for the lateral or transverse control, the Bézier approach according to the disclosure can, with reference to FIG. 2, also be interpreted as an outer control loop, where the calculated course curvature RC_{Bézier} (for t=0) (as the target value for the course curvature) represents an input parameter for an inner control loop of the lateral control. The calculation of the Bézier curve in function block 30 forms a part of the outer control loop, which receives signals from a camera looking forwards, i.e. in a direction of travel, and outputs a signal for the inner control loop which, in the exemplary embodiment, comprises a PID controller 50.

The lateral or transverse control here takes place on the basis of a deviation between a target course curvature of the movement path determined by function block 30 and an actual course curvature of the movement path of the vehicle 5 determined in function block 40, and delivers a steering torque to an electrically-assisted steering system as an output signal.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A driver assistance system for a vehicle comprising:
an electrically-assisted steering system configured to apply a steering torque that automates transverse vehicle control, having a camera configured to record images of a traffic lane in front of the vehicle; and
a controller configured to determine a target value for a course curvature of a movement path of the vehicle through calculation of a Bézier curve using the images.

2. The driver assistance system as claimed in claim 1, wherein the controller is configured to determine, from the images recorded from the camera, a current course curvature of a roadway, a distance between a center line of the roadway and a center of gravity of the vehicle, and an angle between the center line of the roadway and a center line of the vehicle.

3. The driver assistance system as claimed in claim 1, wherein the Bézier curve is a cubic Bézier curve.

4. The driver assistance system as claimed in claim 1, wherein the controller is configured to, in response to a current vehicle movement, determine the target value.

5. The driver assistance system as claimed in claim 1, wherein the controller is configured to, in response to a processing delay of the images of the traffic lane, determine the target value.

6. The driver assistance system as claimed in claim 1, wherein the controller is configured to, in response to different task times of the images of the traffic lane and the steering system, determine the target value.

7. The driver assistance system as claimed in claim 1, wherein the controller is configured to calculate a yaw rate of the vehicle with reference to the Bézier curve.

8. The driver assistance system as claimed in claim 1, wherein the controller is configured to, in response to the target value being indicative of the course curvature of the movement path, activate the steering system to apply the steering torque that automates transverse vehicle control.

9. The driver assistance system as claimed in claim 8, wherein the controller is a PID controller.

10. A vehicle comprising:
a driver-assistance system configured to activate an electrically-assisted steering system configured to automate transverse vehicle control via steering torque, and having a camera configured to record images indicative of a traffic lane; and
a controller configured to, in response to a target value calculated via a Bézier curve using images recorded from the camera and being indicative of a course curvature of a movement path of the vehicle in a traffic lane, activate the steering system to apply the steering torque, wherein the images are indicative of a current course curvature of a roadway, a distance between a center line of the roadway and a center of gravity of the vehicle, and an angle between the center line of the roadway and a center line of the vehicle.

11. The vehicle as claimed in claim 10, wherein the Bézier curve is a cubic Bézier curve.

12. The vehicle as claimed in claim 10, wherein the controller is configured to, in response to a vehicle movement, calculate the target value.

13. The vehicle as claimed in claim 10, wherein the controller is configured to, in response to a processing delay of the images of the traffic lane, calculate the target value.

14. The vehicle as claimed in claim 10, wherein the controller is configured to, in response to different task times of the images of the traffic lane and the steering system, calculate the target value.

15. The vehicle as claimed in claim 10, wherein the controller is configured to calculate a yaw rate of the vehicle with reference to the Bézier curve.

16. An electrically-assisted steering system comprising:
a controller configured to apply a steering torque to automate transverse vehicle control along a movement path in response to
a target value indicative of a course curvature of the movement path and calculated via a Bézier curve using images of a traffic lane indicative of a current roadway course curvature,
a distance between a roadway center line and a vehicle center of gravity, and
an angle between the roadway center line and a vehicle center line recorded from a camera.

17. The electrically-assisted steering system as claimed in claim 16, wherein the controller is configured to, in response to a vehicle movement, calculate the target value.

18. The electrically-assisted steering system as claimed in claim 16, wherein the controller is configured to, in response to a processing delay of the images of the traffic lane, calculate the target value.

19. The electrically-assisted steering system as claimed in claim 16, wherein the controller is configured to, in response to different task times of the images of the traffic lane and the steering system, calculate the target value.

20. The electrically-assisted steering system as claimed in claim 16, wherein the controller is configured to calculate a vehicle yaw rate with reference to the Bézier curve.
